(19) United States
(12) Patent Application Publication
(10) Pub. No.: US 2020/0385005 A1
(43) Pub. Date: Dec. 10, 2020

(54) BEND CONTROL OPTIMIZATION METHOD AND SYSTEM

(71) Applicant: Jilin University, Changchun City (CN)

(72) Inventors: Zhenhai GAO, Changchun City (CN); Yiteng SUN, Changchun City (CN); Hongyu HU, Changchun City (CN); Fei GAO, Changchun City (CN); Yichi ZHANG, Changchun City (CN); Naixuan ZHU, Changchun City (CN); Yuhuan SHENG, Changchun City (CN)

(21) Appl. No.: 16/802,858

(22) Filed: Feb. 27, 2020

(30) Foreign Application Priority Data
Jun. 4, 2019 (CN) 201910480137.4

(51) Int. Cl. B60W 30/18; B60W 50/00

(52) U.S. Cl. CPC B60W 30/18145; B60W 50/00; B60W 2520/125; B60W 2520/06; B60W 2520/10; B60W 2720/106; B60W 2050/0031; B60W 2530/201; B60W 2520/105

(57) ABSTRACT

The present invention discloses a bend control optimization method and system. The bend control optimization method includes: acquiring lateral motion data of a vehicle, where the lateral motion data includes a steering angle; determining a lateral acceleration according to the lateral motion data; determining a longitudinal acceleration pre-correction amount of the vehicle according to the lateral motion data and the lateral acceleration; determining a longitudinal acceleration correction amount according to the longitudinal acceleration pre-correction amount; and adjusting longitudinal acceleration of the vehicle according to the longitudinal acceleration correction amount to assist the vehicle to conduct bend driving. The bend control optimization method and system provided by the present invention can simultaneously control the longitudinal motion and the lateral motion of the vehicle to improve comfortableness when the vehicle drives into the bend and avoid that the vehicle collides with another vehicle on an adjacent lane when the vehicle drives into and out of a roundabout.

### CROSS REFERENCE TO RELATED APPLICATIONS

The present application claims the benefit of priority under 35 USC 119 to Chinese patent application 201910480137.4, filed Jun. 4, 2019, the contents of which are incorporated herein by reference.

### TECHNICAL FIELD

The present invention relates to the field of vehicle driver assistance, and in particular, to a bend control optimization method and system.

### BACKGROUND

With the gradual maturity of driver-assistance technology, such as an adaptive cruise control system, an automatic emergency braking system, a lane keeping assist system, etc. are widely applied to the vehicle market. However, the current driver-assistance technology mostly independently controls a longitudinal motion or a lateral motion of a vehicle. Therefore, when driving on a bend, e.g., a curve in a roadway, an unskillful driver needs to simultaneously coordinate lateral turn and longitudinal acceleration/deceleration and needs to simultaneously control a steering wheel and a brake or an accelerator by hands and feet. If the driver has poor hand-foot coordination ability, the traditional driver-assistance technology cannot simultaneously control the longitudinal motion and the lateral motion of the vehicle such that a lateral acceleration and a longitudinal acceleration of the vehicle change abruptly to reduce the comfortableness of the vehicle, and when the vehicle drives into and out of a roundabout, the vehicle may collide with another vehicle on an adjacent lane even to cause a traffic accident.

### SUMMARY

An objective of the present invention is to provide a bend or curve control optimization method and system to solve a problem that the traditional driver-assistance technology cannot simultaneously control, which is a longitudinal motion and a lateral motion of a vehicle when a lateral acceleration and a longitudinal acceleration of the vehicle change abruptly to reduce the comfortableness and stability of the vehicle. For example, when the vehicle drives into and out of a roundabout, such instability could cause the vehicle to collide with another vehicle on an adjacent lane to cause a traffic accident.

To achieve the above purpose, the present invention provides the following technical solutions: a bend control optimization method includes acquiring lateral motion data of a vehicle, where the lateral motion data includes a steering angle; determining a lateral acceleration according to the lateral motion data; determining a longitudinal acceleration pre-correction amount of the vehicle according to the lateral motion data and the lateral acceleration; determining a longitudinal acceleration correction amount according to the longitudinal acceleration pre-correction amount; and adjusting longitudinal acceleration of the vehicle according to the longitudinal acceleration correction amount to assist the vehicle to conduct bend driving.

Optionally, determining a lateral acceleration according to the lateral motion data can specifically include determining the lateral acceleration according to a formula:

$${A}_{y} = K \frac{δ}{i L} {V}^{2} ,$$

where A_{y} is the lateral acceleration, K is a speed coefficient, K∈[0.8, 2], δ is the steering angle, i is a steering system transmission ratio, L is a wheelbase, and V is the vehicle speed.

Optionally, determining a longitudinal acceleration pre-correction amount of the vehicle according to the lateral motion data and the lateral acceleration can specifically include acquiring correction conditions; judging or determining whether the lateral motion data and the lateral acceleration meet the correction conditions to obtain a first judging result; determining the longitudinal acceleration pre-correction amount of the vehicle according to a formula:

$${A}_{x} = - \frac{δ {δ}^{•}}{\vert δ {δ}^{•} \vert} {( K \frac{\vert δ \vert}{i L} {V}^{2} )}^{′}$$

if the first judging result represents that the lateral motion data and the lateral acceleration meet the correction conditions, where Aₓ is the longitudinal acceleration pre-correction amount.

Optionally, determining a longitudinal acceleration correction amount according to the longitudinal acceleration pre-correction amount can specifically include determining a longitudinal acceleration correction amount according to a formula:

Ax*=kAx,

where Ax* is the longitudinal acceleration correction amount, k is an acceleration correction coefficient, and the acceleration correction coefficient includes an accelerating correction coefficient and a decelerating correction coefficient.

In accordance with aspects of the inventive concepts, provided is a bend control optimization system that includes a lateral motion data acquiring module, used for acquiring lateral motion data of a vehicle, where the lateral motion data includes a steering angle; a lateral acceleration determining module, used for determining a lateral acceleration according to the lateral motion data; a longitudinal acceleration pre-correction amount determining module, used for determining a longitudinal acceleration pre-correction amount of the vehicle according to the lateral motion data and the lateral acceleration; a longitudinal acceleration correction amount determining module, used for determining a longitudinal acceleration correction amount according to the longitudinal acceleration pre-correction amount; and an adjusting module, used for adjusting longitudinal acceleration of the vehicle according to the longitudinal acceleration correction amount to assist the vehicle to conduct bend driving.

Optionally, the lateral acceleration determining module can specifically include a lateral acceleration determining unit used for determining the lateral acceleration according to a formula:

$${A}_{y} = K \frac{δ}{i L} {V}^{2} ,$$

where A_{y} is the lateral acceleration, K is a speed coefficient, K∈[0.8, 2], δ is the steering angle, i is a steering system transmission ratio, L is a wheelbase, and V is the vehicle speed.

Optionally, the longitudinal acceleration pre-correction amount determining module can specifically include a correction condition acquiring unit, used for acquiring correction conditions; a first judging unit, used for judging whether the lateral motion data and the lateral acceleration meet the correction conditions to obtain a first judging result; and a longitudinal acceleration pre-correction amount determining unit, used for determining the longitudinal acceleration pre-correction amount of the vehicle according to a formula:

$${A}_{x} = - \frac{δ {δ}^{•}}{\vert δ {δ}^{•} \vert} {( K \frac{\vert δ \vert}{i L} {V}^{2} )}^{′}$$

if the first judging result represents that the lateral motion data and the lateral acceleration meet the correction conditions, where Aₓ is the longitudinal acceleration pre-correction amount.

Optionally, the longitudinal acceleration correction amount determining module can specifically include a longitudinal acceleration correction amount determining unit, used for determining a longitudinal acceleration correction amount according to a formula:

Ax*=kAx,

where Ax* is the longitudinal acceleration correction amount, k is an acceleration correction coefficient, and the acceleration correction coefficient includes an accelerating correction coefficient and a decelerating correction coefficient.

According to various aspects of the present invention, the inventive concepts provide the following technical effects: the bend control optimization method and system assist to control the longitudinal motion of the vehicle by reading a current motion state of the vehicle, especially lateral motion data of the vehicle, such as parameters of a steering angle, a lateral acceleration and the like; and when the vehicle drives into the bend and a lateral acceleration is about to sharply increase, the vehicle assists to brake to reduce a vehicle speed in order that the lateral acceleration stably fluctuates and to achieve a function of coordinating the lateral acceleration and the longitudinal acceleration of the vehicle, thereby reducing operations of the driver driving on the bend and helping vehicle bend driving to be more human-friendly, simple, and safe.

In accordance with aspects of the present invention, the bend control optimization method and system can assist in the roll, yaw, and/or pitch of a vehicle driving in a bend.

### BRIEF DESCRIPTION OF THE DRAWINGS

To describe the technical solutions in the embodiments of the present invention or in the prior art more clearly, the following briefly introduces the accompanying drawings required for describing the embodiments. Apparently, the accompanying drawings in the following description show merely some embodiments in accordance with aspects of the present invention, and a person of ordinary skill in the art may still derive other accompanying drawings and embodiments from these accompanying drawings without creative efforts.

FIG. 1 is a flow chart of an embodiment of a bend control optimization method, in accordance with aspects of the present invention.

FIG. 2 is a flow chart of an embodiment of a bend control optimization method based on a vehicle control system, in accordance with aspects of the present invention.

FIG. 3 is a structural diagram of an embodiment of a bend control optimization system, in accordance with aspects of the present invention.

### DETAILED DESCRIPTION

The following clearly and completely describes various technical solutions in the form of embodiments in accordance with the present invention and with reference to accompanying drawings. Apparently, the described embodiments are merely a part, rather than all, of the embodiments of the present invention. All other embodiments obtained by a person of ordinary skill in the art based on the embodiments of this disclosure without creative efforts shall fall within the scope of the present invention.

An objective of the present invention is to provide a bend control optimization method and system, which can simultaneously control a longitudinal motion and a lateral motion of a vehicle to improve comfortableness and stability when the vehicle drives into a bend and to effectively avoid a problem that the vehicle collides with another vehicle on an adjacent lane when the vehicle drives into and out of a roundabout.

To make the foregoing objective, features, and advantages of the present invention more apparent and more comprehensible, embodiments in accordance with the present invention are further described in detail below with reference to the accompanying drawings and specific embodiments.

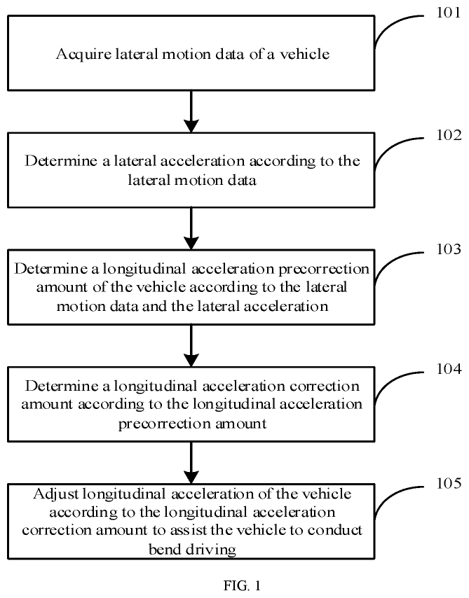

FIG. 1 is a flow chart of an embodiment of a bend control optimization method in accordance with aspects of the present invention. As shown in FIG. 1, the bend control optimization method includes a step 101 for acquiring lateral motion data of a vehicle, where the lateral motion data includes a steering angle. An information acquisition module is connected with the vehicle through an on-board diagnostics (OBD) interface to, in real time, read vehicle data such as the steering angle, vehicle speed and the like. A step 102 includes determining a lateral acceleration according to the lateral motion data, where the step 102 can specifically include determining the lateral acceleration according to a formula:

$${A}_{y} = K \frac{δ}{i L} {V}^{2} ,$$

where A_{y} is the lateral acceleration, K is a speed coefficient, K∈[0.8, 2], K is respectively calibrated at each vehicle speed according to different vehicle models, δ is the steering angle, i is a steering system transmission ratio, L is a wheelbase, and V is the vehicle speed.

A step 103 includes determining a longitudinal acceleration pre-correction amount of the vehicle according to the lateral motion data and the lateral acceleration. The step 103 can specifically include acquiring correction conditions, where the correction conditions are: (1) the vehicle speed greater than 20 km/h, (2) the steering angle greater than 10 degrees, and (3) the lateral acceleration |Ay| greater than 2 m/s². After the above conditions are met at the same time, the method can include judging or determining whether the lateral motion data and the lateral acceleration meet the correction conditions; and if yes, determining the longitudinal acceleration pre-correction amount of the vehicle according to a formula:

$${A}_{x} = - \frac{δ {δ}^{•}}{\vert δ {δ}^{•} \vert} {( K \frac{\vert δ \vert}{i L} {V}^{2} )}^{′} ,$$

where Aₓ is the longitudinal acceleration pre-correction amount.

A step 104 includes determining a longitudinal acceleration correction amount according to the longitudinal acceleration pre-correction amount, where the step 104 specifically includes determining a longitudinal acceleration correction amount according to a formula:

Ax*=kAx,

where Ax* is the longitudinal acceleration correction amount, k is an acceleration correction coefficient, and the acceleration correction coefficient includes an accelerating correction coefficient and a decelerating correction coefficient. The step further includes calculating the longitudinal acceleration pre-correction amount Ax, and then judging whether this value is positive or negative so as to calculate the longitudinal acceleration correction amount Ax*; wherein:

if Ax is a positive value: Ax*=k1Ax;

if Ax is a negative value: Ax*=k2Ax;

where k₁ is an accelerating correction coefficient and its value range is (0,1), and k₂ is a decelerating correction coefficient and its value range is (0,1).

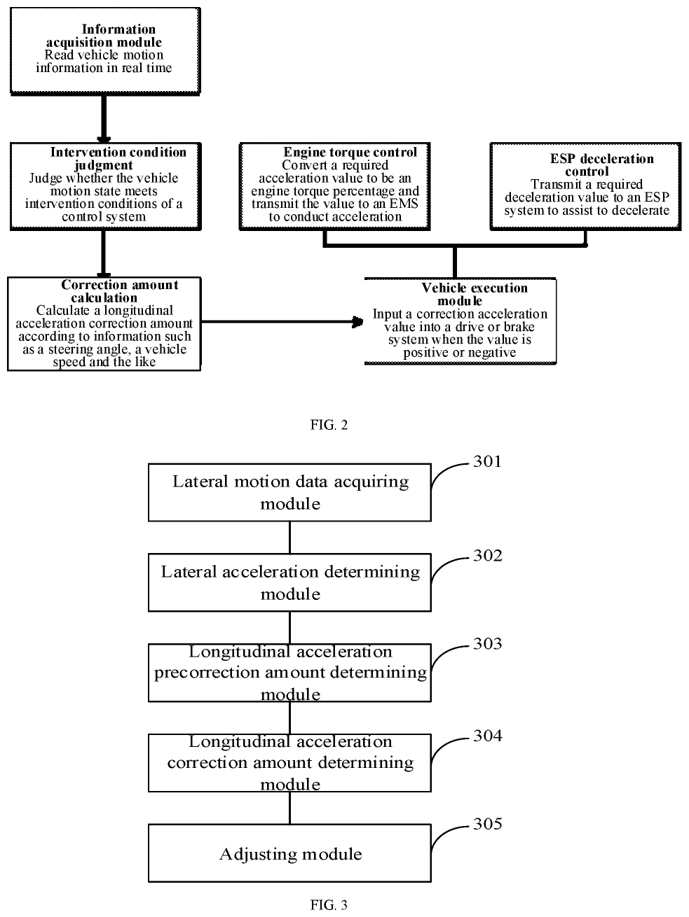

A step 105 includes adjusting longitudinal acceleration of the vehicle according to the longitudinal acceleration correction amount to assist the vehicle to conduct bend driving. This step includes, according to the acceleration correction amount Ax*, input the value into an execution system, namely a drive system or a brake system; When Ax* is a positive value, assist the vehicle to accelerate, add the value and a response acceleration value of an acceleration position of the driver to obtain a sum, input the sum into the engine management system (EMS), and output in a form of engine torque percentage, where the EMS is an original EMS system of the vehicle. When Ax* is a negative value, assist the vehicle to brake, transmit the deceleration value to an Electronic Stability Program (ESP), enable the vehicle to respond and decelerate, and return the step 101, where the ESP system is an original ESP system of the vehicle, as shown in FIG. 2.

FIG. 3 is a structural diagram of an embodiment of a bend control optimization system provided in accordance with the present invention. As shown in FIG. 3, the bend control optimization system includes a lateral motion data acquiring module 301, used for acquiring lateral motion data of a vehicle, where the lateral motion data includes a steering angle. A lateral acceleration determining module 302 is used for determining a lateral acceleration according to the lateral motion data. In various embodiments, the lateral acceleration determining module 302 specifically includes a lateral acceleration determining unit used for determining the lateral acceleration according to a formula:

$${A}_{y} = K \frac{δ}{i L} {V}^{2} ,$$

where A_{y} is the lateral acceleration, K is a speed coefficient, K∈[0.8, 2], δ is the steering angle, i is a steering system transmission ratio, L is a wheelbase, and V is the vehicle speed.

The system further includes a longitudinal acceleration pre-correction amount determining module 303, used for determining a longitudinal acceleration pre-correction amount of the vehicle according to the lateral motion data and the lateral acceleration. In various embodiments, the longitudinal acceleration pre-correction amount determining module 303 specifically includes a correction condition acquiring unit, used for acquiring correction conditions, a first judging unit, used for judging whether the lateral motion data and the lateral acceleration meet the correction conditions to obtain a first judging result, and a longitudinal acceleration pre-correction amount determining unit used for determining the longitudinal acceleration pre-correction amount of the vehicle according to a formula:

$${A}_{x} = - \frac{δ {δ}^{•}}{\vert δ {δ}^{•} \vert} {( K \frac{\vert δ \vert}{i L} {V}^{2} )}^{′} ,$$

if the first judging result represents that the lateral motion data and the lateral acceleration meet the correction conditions, where Aₓ is the longitudinal acceleration pre-correction amount.

The system further includes a longitudinal acceleration correction amount determining module 304, used for determining a longitudinal acceleration correction amount according to the longitudinal acceleration pre-correction amount. In various embodiments, the longitudinal acceleration correction amount determining module 304 specifically includes a longitudinal acceleration correction amount determining unit, used for determining the longitudinal acceleration correction amount according to a formula:

Ax*=kAx,

where Ax* is the longitudinal acceleration correction amount, k is an acceleration correction coefficient, and the acceleration correction coefficient includes an accelerating correction coefficient and a decelerating correction coefficient; and

The system further includes an adjusting module 305, used for adjusting longitudinal acceleration of the vehicle according to the longitudinal acceleration correction amount to assist the vehicle to conduct bend driving.

To assist a driver with coordinating the lateral motion and the longitudinal motion of the vehicle in a vehicle turning procedure and help a hand-foot coordination operation of the driver, the present invention can adaptively adjust the longitudinal motion of the vehicle according to the current lateral motion state of the vehicle such that the lateral acceleration and the longitudinal acceleration do not sharply fluctuate. As a result, the vehicle drives more stably and rides more comfortably, operations are reduced when the driver drives on the bend, and the driver can easily coordinate and control the hands and the feet. Driving the vehicle in bends, including roundabouts, is more human-friendly, simple, and safe.

The present invention remarkably reduces the lateral acceleration of the vehicle by slightly increasing the longitudinal acceleration (its absolute value) of the vehicle, that is, a combined acceleration (its absolute value) of the vehicle is reduced, so that the driver rides comfortably, stably, and safely.

The present invention has at least the following beneficial effects as compared with the prior art:
(1) the longitudinal motion of the vehicle is adjusted according to the lateral motion state of the vehicle, and different from another driver-assistance algorithm of independently considering lateral control and longitudinal control, the anthropomorphic bend control optimization algorithm in real time finely adjusts the longitudinal acceleration of the vehicle according to the real-time lateral motion state of the vehicle on the bend such that the lateral acceleration and the longitudinal acceleration are reduced in a vehicle turning procedure, the vehicle moves stably, and the driver rides comfortably; and
(2) the vehicle adaptively adjusts the longitudinal motion of the vehicle in the vehicle turning procedure so as to ensure operation and control of the vehicle to be more human-friendly, to be capable of improving a coordination ability of an unskilled driver and a common driver to control the vehicle and simultaneously make a turn and accelerate or decelerate, and to avoid a traffic accident.

Each embodiment of the present specification is described in a progressive manner, each embodiment focuses on the difference from other embodiments, and the same and similar parts between the embodiments may refer to each other. For a system disclosed in the embodiments, since it corresponds to the method disclosed in the embodiments, the description is relatively simple, and reference can be made to the method description.

Several examples are used for illustration of the principles and implementation methods of the present invention. The description of the embodiments is used to help illustrate the method and core principles of the present invention. In addition, a person of ordinary skill in the art can make various modifications in terms of specific embodiments and scope of application in accordance with the teachings of the present invention. In conclusion, the content of this specification shall not be construed as a limitation to the present invention. Rather, the embodiments provided herein are merely illustrative and the scope of the invention shall be determined by the claims.

1. A bend control optimization method, comprising:
acquiring lateral motion data of a vehicle, wherein the lateral motion data comprises a steering angle;
determining a lateral acceleration according to the lateral motion data;
determining a longitudinal acceleration pre-correction amount of the vehicle according to the lateral motion data and the lateral acceleration;
determining a longitudinal acceleration correction amount according to the longitudinal acceleration pre-correction amount; and
adjusting longitudinal acceleration of the vehicle according to the longitudinal acceleration correction amount to assist the vehicle to conduct bend driving.

2. The bend control optimization method according to claim 1, wherein the determining a lateral acceleration according to the lateral motion data specifically comprises:
determining the lateral acceleration according to a formula:
$${A}_{y} = K \frac{δ}{i L} {V}^{2} ,$$
wherein A_{y} is the lateral acceleration, K is a speed coefficient, K∈[0.8, 2], δ is the steering angle, i is a steering system transmission ratio, L is a wheelbase, and V is the vehicle speed.

3. The bend control optimization method according to claim 2, wherein the determining a longitudinal acceleration pre-correction amount of the vehicle according to the lateral motion data and the lateral acceleration specifically comprises:
acquiring correction conditions;
judging whether the lateral motion data and the lateral acceleration meet the correction conditions to obtain a first judging result; and
determining the longitudinal acceleration pre-correction amount of the vehicle according to a formula:
$${A}_{x} = - \frac{δ {δ}^{•}}{\vert δ {δ}^{•} \vert} {( K \frac{\vert δ \vert}{i L} {V}^{2} )}^{′} ,$$
if the first judging result represents that the lateral motion data and the lateral acceleration meet the correction conditions, wherein Aₓ is the longitudinal acceleration pre-correction amount.

4. The bend control optimization method according to claim 3, wherein the determining a longitudinal acceleration correction amount according to the longitudinal acceleration pre-correction amount specifically comprises:
determining a longitudinal acceleration correction amount according to a formula:
Ax*=kAx,
wherein Ax* is the longitudinal acceleration correction amount, k is an acceleration correction coefficient, and the acceleration correction coefficient comprises an accelerating correction coefficient and a decelerating correction coefficient.

5. A bend control optimization system, comprising:
a lateral motion data acquiring module configured to acquire lateral motion data of a vehicle, wherein the lateral motion data comprises a steering angle;
a lateral acceleration determining module configured to determine a lateral acceleration according to the lateral motion data;
a longitudinal acceleration pre-correction amount determining module configured to determine a longitudinal acceleration pre-correction amount of the vehicle according to the lateral motion data and the lateral acceleration;
a longitudinal acceleration correction amount determining module configured to determine a longitudinal acceleration correction amount according to the longitudinal acceleration pre-correction amount; and
an adjusting module configured to adjust longitudinal acceleration of the vehicle according to the longitudinal acceleration correction amount to assist the vehicle to conduct bend driving.

6. The bend control optimization system according to claim 5, wherein the lateral acceleration determining module specifically comprises:
a lateral acceleration determining unit used for determining the lateral acceleration according to a formula:
$${A}_{y} = K \frac{δ}{i L} {V}^{2} ,$$
wherein A_{y} is the lateral acceleration, K is a speed coefficient, K∈[0.8, 2], δ is the steering angle, i is a steering system transmission ratio, L is a wheelbase, and V is the vehicle speed.

7. The bend control optimization system according to claim 6, wherein the longitudinal acceleration pre-correction amount determining module specifically comprises:
a correction condition acquiring unit configured to acquire correction conditions;
a first judging unit configured to judge or determine whether the lateral motion data and the lateral acceleration meet the correction conditions to obtain a first judging result; and
a longitudinal acceleration pre-correction amount determining unit configured to determine the longitudinal acceleration pre-correction amount of the vehicle according to a formula:
$${A}_{x} = - \frac{δ {δ}^{•}}{\vert δ {δ}^{•} \vert} {( K \frac{\vert δ \vert}{i L} {V}^{2} )}^{′}$$
if the first judging result represents that the lateral motion data and the lateral acceleration meet the correction conditions, wherein Aₓ is the longitudinal acceleration pre-correction amount.

8. The bend control optimization system according to claim 7, wherein the longitudinal acceleration correction amount determining module specifically comprises:
a longitudinal acceleration correction amount determining unit configured to determine a longitudinal acceleration correction amount according to a formula:
Ax*=kAx,
wherein Ax* is the longitudinal acceleration correction amount, k is an acceleration correction coefficient, and the acceleration correction coefficient comprises an accelerating correction coefficient and a decelerating correction coefficient.
